(19) United States
(12) Patent Application Publication
(10) Pub. No.: US 2009/0212031 A1
(43) Pub. Date: Aug. 27, 2009

(54) Method for Producing a Sealing Ring

(75) Inventors: Hermann Stahl, Steinheim (DE); Norbert Schnabel, Abtsteinach (DE)

Correspondence Address: Davidson, Davidson & Kappel, LLC, 485 7th Avenue, 14th Floor, New York, NY, 10018, US

(73) Assignee: Carl Freudenberg KG, Weinheim (DE)

(21) Appl. No.: 12/223,681

(22) PCT Filed: Feb. 1, 2007
(86) PCT No.: PCT/EP2007/000863

§ 371 Date: Jan. 14, 2009

(30) Foreign Application Priority Data
Feb. 10, 2006 (EP) 06002713.3

(51) Int. Cl. B23K 26/00

(52) U.S. Cl. 219/121.72; 219/121.85

(57) ABSTRACT

A method for producing a sealing ring in which a hollow cylinder is first formed from a sheet metal, the mutually contacting edges of the sheet metal being joined in a substance-to-substance bond, the bond being produced in such a way that a bead is formed at least on the outer periphery, along the mutually contacting edges, and is flattened in a subsequent working process.

This is a National Phase application of PCT/EP2007/00863 filed on Feb. 1, 2007, and claims the benefit of EP 06002713.3 filed on Feb. 10, 2006, through PCT/EP2007/00863 filed on Feb. 1, 2007.

The present invention relates to a method for producing a sealing ring in which a hollow cylinder is first formed from a sheet metal, the mutually contacting edges of the sheet metal panel being joined in a substance-to-substance bond.

### BACKGROUND OF THE INVENTION

A method of this kind is known from the German Patent Application DE 197 55 391 A1. It discusses first fabricating a hollow cylinder from a sheet-metal strip and of then reshaping it into a supporting ring in a postdeformation process. The mutually contacting edges are joined together in a substance-to-substance bond by welding or soldering. The postdeformation can be accomplished by roll-forming or deep-drawing, it being possible for the supporting ring to be provided with various contours. Supporting rings must generally exhibit a superior surface quality, at least on the outer periphery, since this surface forms a static sealing surface for sealing the sealing ring against a housing. To that end, a good roundness profile and minimal roughness are necessary. When soldering is used for the joining process, it is disadvantageous that a good capillary effect can only be achieved when the distance between the mutually contacting edges is small and when the surfaces are wettable. In the case of a substance-to-substance bond produced by welding, concave depressions frequently form at the join due to material creep. These concave depressions can lead to leakiness of the sealing ring.

### SUMMARY OF THE INVENTION

An object of the present invention may provide a method for producing a sealing ring that may make it possible to manufacture sealing rings having a high degree of static leak tightness and minimal material requirements.

This objective may be achieved by a method for producing a sealing ring in which a hollow cylinder is first formed from a sheet metal, the mutually contacting edges of the sheet metal being joined in a substance-to-substance bond, the bond being produced in such a way that a bead is formed at least on the outer periphery, along the mutually contacting edges, and is flattened in a subsequent working process.

The method of the present invention for producing a sealing ring provides for a hollow cylinder to first be formed from a sheet metal, the mutually contacting edges of the sheet metal being joined in a substance-to-substance bond, the bond being produced in such a way that a bead is formed at least on the outer periphery, along the mutually contacting edges, and is flattened in a subsequent working process. A bead is simpler to even out in a later working step than is a concave depression which requires subsequently introducing material. The method is also advantageous in comparison to resistance pressure welding, which requires positioning the edges in an overlapping configuration and then welding them together. This method leads to an unfavorable structure and an unfavorable surface shape at the join. When working with resistance welding, excess material next to the separation site is weld-cladded and can become detached later. When the method according to the present invention is employed, an especially good surface quality, a good static leak tightness, as well as minimal roundness deviations are obtained. Precise edges are obtained at the separation site by centrically trimming the rounded body blank on both sides. In this context, a portion, which, due to the lever forces, does not have the desired radius when the hollow cylinder is formed, is removed from each edge. A precise developed length, which is not influenced by any forming process, is also thereby achieved in the context of negligible roundness deviations. In the case of the method according to the present invention, pretreated, for example, phosphatized sheet metals may be advantageously used. The method according to the present invention and the laser welding process, in particular, only have an insignificant effect on this pretreatment. The zone affected by heat in the laser welding process is small, so that the pretreatment is only negligibly affected. It is more cost-effective to pretreat the sheet metals than it is to pretreat the finished supporting rings.

The edges may be joined together by welding. Welding is a method that is suited for large-scale production and for highly automated processes. There is no need to pretreat the edges to be joined.

The edges may be joined together by laser-beam welding. In this method, a high level of energy is input over a small cross section, thereby yielding only a small zone of molten material. The result is only a slight microstructural change. The welding tool is nonwearing.

Flux may be used to assist the welding process. When a flux-assisted welding is carried out, a bead having a defined height, having a height of less than 0.1 mm in one preferred embodiment, is formed. This bead may be readily produced in a flux-assisted welding process. The structure of the weld may be positively influenced by the flux selection.

Prior to the subsequent working, annular blanks may be sliced off of the hollow cylinder. In the process, a long hollow cylinder is first produced, from which annular blanks are sliced off following the substance-to-substance bonding. This reduces the number of required welding processes.

The subsequent working may be accomplished by roll-forming. The stresses produced in the structure by the forming thereof are reduced by plastic deformation in the roll-forming process. A great variety of forms may be achieved using one tool.

The subsequent working may be accomplished by deep-drawing. Deep-drawing is a rapid process which makes it possible for high piece numbers to be produced in a short period of time.

The subsequent working may be accomplished by a machine-cutting process. Depending on the process, the surface quality may be influenced in the process. Moreover, other geometries, including complex geometries, may be introduced into the outer periphery. Possible machine-cutting processes include turning on a lathe, milling and grinding.

The sheet metal may have a punched hole. In this context, the sheet metal may have a hole pattern. This permits a more effective bonding to the elastomers which are applied to the supporting ring to produce a seal. The hole pattern may be introduced into the sheet metal or the sheet-metal strip by punching or laser cutting. It is beneficial in this case that the subsequent working does not degrade the hole pattern. In the case of the subsequent working, the tensile stresses introduced into the sheet metal are negligible, so that the sheet metal panels featuring the hole pattern do not tear. The hole pattern improves the bond formed with the elastomer to be sprayed on. Under certain circumstances, it may eliminate the need for pretreating, for example phosphatizing, the supporting ring. The punched hole is introduced into the sheet metal prior to the forming process and is not adversely affected by the subsequent working in the cylindrical area.

Another approach for achieving the objective provides for a supporting ring for a seal to be obtained by a method as set forth in one of the claims.

### BRIEF DESCRIPTION OF THE DRAWING

The method according to the present invention, as well as a sealing ring according to the present invention are clarified in the following with reference to the figures.

FIG. 1 through 4 illustrate the process for producing a supporting ring of a seal according to the present invention.

FIG. 5 shows a seal according to the present invention.

FIG. 6 shows a supporting ring having a hole pattern.

### DETAILED DESCRIPTION

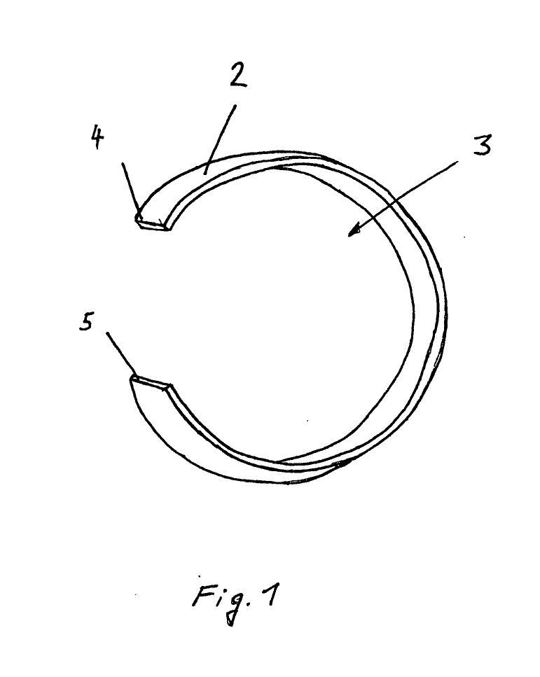

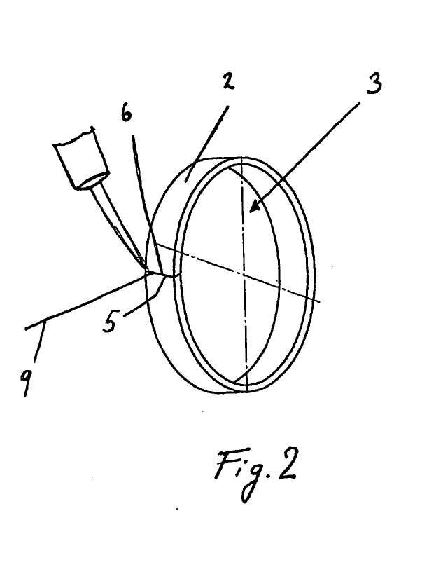

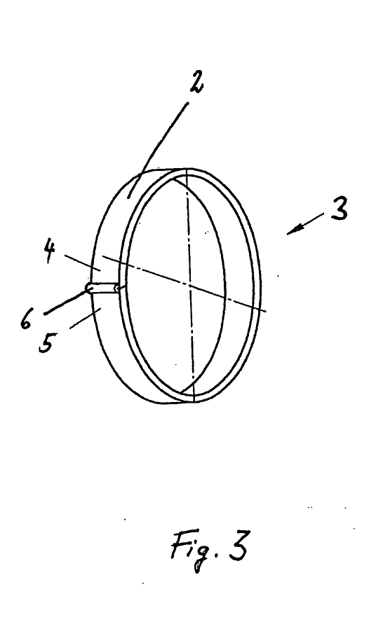

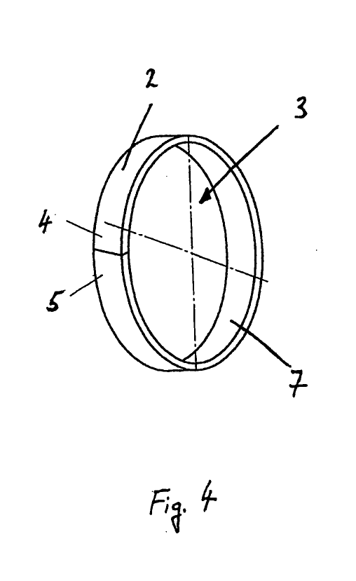

FIG. 1 through 4 illustrate the method according to the present invention for producing a sealing ring 1. In this context, a hollow cylinder 3 is first formed from a sheet metal 2, for example by roll-forming (FIG. 1). In a next step, mutually contacting edges 4, 5 of sheet metal 2, which is formed into a hollow cylinder 3, are joined together in a substance-to-substance bond. For that purpose, edges 4, 5 are mutually butted and welded together in a substance-to-substance bond by laser-beam welding assisted by the feeding of a flux 9 (FIG. 2). The bond is produced in such a way that a bead 6 is thereby formed along mutually contacting edges 4, 5, at least on the outer periphery (FIG. 3). This bead 6 is flattened in a subsequent working, which in this case is carried out as a roll-forming process. Other embodiments provide for the subsequent working to be carried out as a deep-drawing or a machine-cutting process, such as by turning on a lathe, milling or grinding, for example. To reduce welding operations, a hollow cylinder 3 may also be first produced, from which annular blanks 7 may be sliced off prior to the subsequent working.

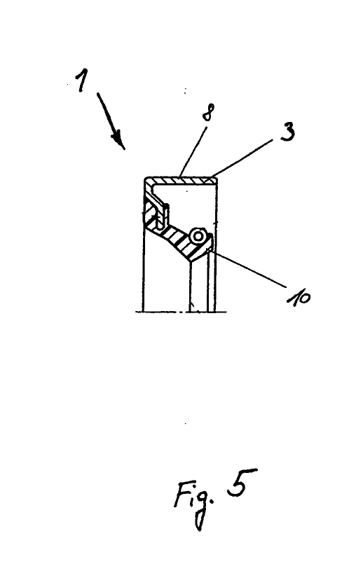

FIG. 5 shows a sealing ring 1 having a supporting ring 8. Supporting ring 8 is formed by a hollow cylinder 3 that had been produced using the previously described method. A sealing lip 10 that provides dynamic sealing action is vulcanized onto supporting ring 8. A sheet metal 2, which had undergone a phosphatizing pretreatment to enhance the adhesive strength of the elastomer material, was used for supporting ring 8.

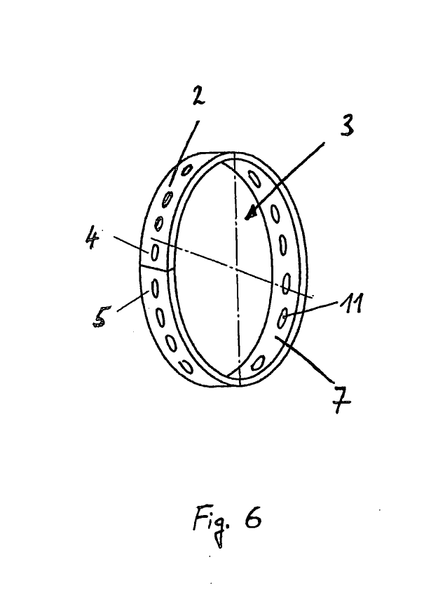

FIG. 6 shows a supporting ring 8 that was produced using the previously described method. Supporting ring 8 features a hole pattern 11 composed of individual holes that had been punched uniformly into sheet metal 2 prior to the forming of the hollow cylinder.

11. A method for producing a sealing ring comprising:
first forming a hollow cylinder from a sheet metal, joining mutually contacting edges of the sheet metal in a substance-to-substance bond, the bond being produced in such a way that a bead is formed at least on an outer periphery; along the mutually contacting edges; and
flattening the bead in a subsequent working process.

12. The method as recited in claim 11, wherein the edges are joined together by welding.

13. The method as recited in claim 11, wherein the edges are joined together by laser-beam welding.

14. The method as recited in claim 12, wherein a flux is used to assist the welding process.

15. The method as recited in claim 11, wherein, prior to the subsequent working, annular blanks are sliced off of the hollow cylinder.

16. The method as recited in claim 11, wherein the subsequent working is accomplished by roll-forming.

17. The method as recited in claim 11, wherein the subsequent working is accomplished by deep-drawing.

18. The method as recited in claim 11, wherein the subsequent working is accomplished by a machine-cutting process.

19. The method as recited in claim 11, wherein the sheet metal has a hole pattern.

20. A supporting ring for a sealing ring formed by the method as recited in claim 11.
